(19) United States
(12) Patent Application Publication
(10) Pub. No.: US 2026/0054708 A1
(43) Pub. Date: Feb. 26, 2026

(54) 3/2 DIRECTIONAL VALVE CONCEPT FOR HYDRAULIC ACTUATION SYSTEM

(71) Applicant: Heinz LEIBER, Oberriexingen (DE)

(72) Inventor: Heinz LEIBER, Oberriexingen (DE)

(21) Appl. No.: 19/375,800

(22) Filed: Oct. 31, 2025

Related U.S. Application Data
(63) Continuation of application No. PCT/EP2024/061924, filed on Apr. 30, 2024.

(30) Foreign Application Priority Data
May 3, 2023 (DE) 10 2023 111 467.0

(51) Int. Cl. B60T 13/74; B60T 13/68

(52) U.S. Cl. CPC B60T 13/745; B60T 13/686

(57) ABSTRACT

In a method for operating a brake system including two hydraulic wheel brakes each assigned a switching valve, and an electrically motor-driven pressure supply device including a piston-cylinder system with a double-stroke piston, a first working chamber connected to a first brake circuit via a first hydraulic connection, and a second working chamber connected to a second brake circuit via a second hydraulic connection, at least the first or second hydraulic connection including a 3/2-way valve with which the first or second working chamber is selectively connectable hydraulically to the reservoir in a first switching position and to the first or second brake circuit, before the 3/2-way valve is switched to its second switching position where the hydraulic connection is established between the first or second working chamber and the hydraulic connection leading to the switching valves, reducing a hydraulic pressure acting at least on a valve to be switched.

### CROSS REFERENCE TO RELATED APPLICATIONS

This application claims the benefit of priority to German Patent Application No. 10 2023 111 467.0 filed on May 3, 2023 and is a Continuation Application of PCT Application No. PCT/EP2024/061924 filed on Apr. 30, 2024. The entire contents of each application are hereby incorporated herein by reference.

### BACKGROUND OF THE INVENTION

### 1. Field of the Invention

The present invention relates to braking systems each including at least two hydraulic wheel brakes.

### 2. Description of the Related Art

Hydraulic actuation systems are well known. In automotive engineering, 3/2-way valves are used in a variety of applications, as disclosed in DE 10 2017000472, where a 3/2-way valve is used to selectively connect a brake circuit to a pressure supply device or to a tandem master brake cylinder. The use of a 3/2-way valve has the advantage of eliminating one valve when only 2/2-way valves were previously used.

In many valve applications, the safety requirements for valve failure are high, as they can affect braking performance and pedal characteristics.

### SUMMARY OF THE INVENTION

Example embodiments of the present invention provide generic hydraulic actuation systems, in particular, for brake systems, each being more fail-safe and cost-effective.

An actuation system according to an example embodiment of the present invention allows pressure to be regulated or controlled very precisely.

A pressure supply device according to an example embodiment of the present invention can advantageously include a piston pump. There is a wide range of applications for actuation systems according to example embodiments of the present invention in automotive engineering. Compared to rotary pumps, electrically driven piston-cylinder systems with plunger or double-stroke pistons offer great advantages in continuous medium delivery or in controlled volume delivery via piston stroke measurement or pressure measurement, and, if necessary, motor current measurement, such that, for example, a specific volume of a hydraulic fluid is displaced by controlled or regulated adjustment of the piston, allowing a specified pressure in a brake circuit to be set or regulated, for example, based on a pressure-volume characteristic curve.

However, it is particularly advantageous if the pressure supply device includes a double-stroke piston so that hydraulic fluid can be delivered during forward and return strokes, and so that each working chamber of the pressure supply device can be connected to a reservoir via a 3/2-way valve assigned to it in particular. With this valve circuit described above, each of the currently required functions of a brake system can be realized or set with the piston, for example. Among other things, it is also possible to adjust the double-stroke piston of the pressure supply device without conveying hydraulic fluid into the brake circuit(s), which is generally referred to as an empty stroke without volume conveyance into or out of the hydraulic circuits or brake circuits. This improves piston positioning at the end of the stroke in some cases.

However, it is also possible that when using a double-acting piston pump (DHK), only one working chamber or brake circuit is assigned a 3/2-way valve and the other is assigned only a 2/2-way valve. With this arrangement, it is then only possible to connect one brake circuit to the reservoir via the 3/2-way valve in order to discharge hydraulic fluid into the reservoir or draw hydraulic fluid from the reservoir.

Even if a 3/2-way valve fails, e.g., during the forward stroke, the second 3/2-way valve can be used to operate the brake circuit BK or both brake circuits BKs via the return stroke. This is an important redundant safety feature.

In another example embodiment, the two working chambers of the pressure supply device can be connected to the reservoir via a single 3/2-way valve, whereby at least one working chamber is always hydraulically connected to the reservoir. If the 3/2-way valve can be held in an intermediate position by an electromagnetic drive, it is also possible for both working chambers of a piston-cylinder unit of the pressure supply device to be hydraulically connected to the reservoir at the same time.

If a hydraulic actuation system with a double-stroke piston according to an example embodiment of the present invention is used for pressure control of a brake system, the hydraulic actuation system can deliver the hydraulic fluid to both brake circuits in both the forward and reverse strokes. In the event of a brake circuit failure (circuit failure), the advantageous valve circuit can still regulate the pressure in the other brake circuit that is still intact, by using the actuation system.

The brake system can advantageously include a master brake cylinder that is a tandem or single master brake cylinder. The master brake cylinder thus has at least one working chamber, which can be connected via a 3/2-way valve either to a brake circuit in a fail-safe mode or, in a normal case, to a road simulator to adjust the pedal feel. If the master brake cylinder is a tandem master brake cylinder with two working chambers, one working chamber can be connected to the brake circuit and the road simulator via a 3/2-way valve as described above, and the other working chamber can be disconnected from the other brake circuit or connected to it in the fail-safe mode via a 2/2-way valve.

The double-stroke piston can be used advantageously for approximately twenty different operations with the valve circuit according to an example embodiment of the present invention if it is to perform these operations without compromising dynamics and positioning accuracy. In contrast to the complex valve circuits known from DE 10 20110830312 or DE 10 2018221783, a valve circuit of a hydraulic actuation system according to an example embodiment of the present invention is significantly simpler, more cost-effective, smaller in design, and also more fail-safe.

Even if one hydraulic circuit fails, the other circuit is still operational in an actuation system according to an example embodiment of the present invention. Providing a redundant motor winding also achieves a higher level of reliability for the drive. A valve circuit according to an example embodiment of the present invention is also flexible in its application, so that it can also be used for the most diverse requirements of the hydraulic unit in ABS, ESP with different valve circuits, and other assistance functions.

To increase safety, an additional valve, in particular a safety shut-off valve, that is closed when de-energized, which disconnects the hydraulic connection between the reservoir and the 3/2-way valve, especially in the event of a malfunction and/or leakage of the 3/2-way valve, may be provided. This has the advantage that, even if the 3/2-way valve is leaking, pressure can still be built up or changed in at least one wheel brake by the pressure supply device by closing the additional safety shut-off valve.

The use of only one valve SiV only has an effect in the fall-back level in the event of failure of the DHK double-stroke piston of the pressure supply device, in order to prevent total brake failure in the event of a double fault: a) a defective double-stroke piston DHK, and b) a leaking 3/2 MV. If each return flow from the DHK to the VB is to be secured, two SiV valves would have to be provided for the pre-stroke working chamber VH and the return stroke working chamber RH.

A significant flow rate/time is required for rapid pressure build-up in the brake circuit, which is also specified in TTL (Time To Lock), e.g., 100/bar in 150 ms. The valve seats, especially for the hydraulic connection from the pressure supply device to the brake circuit, must therefore be designed accordingly with large cross-sectional flow areas or valve flow cross-sectional areas, which become effective when switching at high pressure, as is necessary, for example, when switching from forward stroke to return stroke or vice versa during pressure build-up and pressure reduction. The large valve flow cross-sectional areas also result in a large valve seat area, which means that the opening force of the valve seat is also large. Normal switching of the valves, for example, involves high magnetic forces at 100 bar or a maximum of 220 bar and corresponding dimensioning of the magnetic circuit if the pressure drop, i.e., the efficiency of the double-stroke piston DHK, is to be, e.g., greater than 90%. This would mean significantly higher construction volumes for the 3/2-way valve, costs, and switching times.

This is solved by a valve circuit according to an example embodiment of the present invention and/or a method according to an example embodiment of the present invention, in which the wheel circuits or wheel brake cylinders are decoupled from the pressure supply device or the portion of the brake circuit via previously existing valves, which is done by closing corresponding switching valves, after which the pressure in the 3/2-way valve either by correspondingly adjusting the piston of the pressure supply device and/or establishing a connection to the reservoir tank or, if the pressure in the master brake cylinder is below the switching pressure of the 3/2-way valve PD1 or PD2, the master brake cylinder is lowered to that extent. If the pressure is sufficiently low, the 3/2-way valve can also switch reliably with a small drive even with a large valve flow cross-section or large valve seat. This has the advantage that a standard 3/2 solenoid directional control valve with a small solenoid circuit can be used. This switching strategy according to an example embodiment of the present invention does result in a small additional switching time loss during pressure build-up or pressure reduction. However, this is acceptable because switching to the opposite stroke or the further pressure build-up or pressure reduction via the other stroke direction rarely occurs only at the end of the stroke. Also important for the entire system is the brake circuit design with corresponding valves and connection to the master brake cylinder, which can be a single master brake cylinder SHZ with only one working chamber or a tandem master brake cylinder THZ with two working chambers.

In a braking system and a method according to an example embodiment of the present invention, conventional inlet switching valves with integrated or parallel-connected check valves may be used. However, the use of switching valves is particularly advantageous. These are modified inlet valves which are connected upstream of the wheel brake cylinders and are designed without check valves. This advantageously creates a brake system in which up to four wheel circuits are formed, resulting in an enormous gain in safety during pressure build-up and pressure reduction when switched and controlled appropriately, and also offers the possibility of simplifying the valve switching, e.g., by dispensing with the usual circuit separator valve KTV. With disadvantages for pressure control, the 3/2 solenoid directional control valve used for the return stroke can also be replaced by a more cost-effective, standard 2/2 solenoid directional control valve.

A method according to an example embodiment of the present invention provides that the valve to be switched is depressurized before switching or the pressure difference across the valve is reduced to such an extent that switching the valve with a large valve seat surface into the required switching position can be achieved quickly and safely and without great energy expenditure by a small-sized drive. Particularly when using 3/2-way valves with a large flow cross-sectional area and valve seat area for the hydraulic connection between the pressure supply device or its respective working chamber and the respective brake circuit, the drive of the 3/2-way valve would have to be very powerful without a method according to an example embodiment of the present invention, which would make the valve large and expensive. In a method according to an example embodiment of the present invention, the pressure difference across the 3/2-way valve to be switched next, via which further pressure build-up or reduction is to take place, is reduced by the corresponding valve switching and possibly by a movement of the piston of the pressure supply device to such an extent that the valve can switch reliably with little force. To prevent the pressure already built up in the wheel brake cylinders from dropping undesirably, it is enclosed in the wheel brake cylinders by closing the existing switching valves or the at least one isolating valve present in the brake circuit or additionally provided, after which the pressure on the valve side of the 3/2-way valve to be switched is reduced to such an extent that the 3/2-way valve can switch.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 shows an example embodiment of a hydraulic actuation system to supply pressure to a brake system.

FIG. 1A shows an enlarged detail of the pressure supply device of FIG. 1 with only one 3/2-way valve.

FIGS. 2A and 2B show schematic representations of a 3/2-way valve according to an example embodiment of the present invention in a de-energized state in FIG. 2A and in an energized state in FIG. 2B.

FIG. 3 shows a schematic representation of the actuation system of FIG. 1 with a reservoir VB, a single master brake cylinder SHZ and a 3/2-way valve TV, a valve circuit as in ABS but with switching valves without a check valve SV₁-SV₄ and a pressure supply DV with 3/2-way valves PD1 and PD2.

FIG. 4 shows a schematic representation of the actuation system according to FIG. 3 with an additional 2/2-way valve MVₜ.

FIG. 4A shows the same design as in FIG. 4, but with standard ABS inlet valves with check valves EV₁-EV₄ instead of the switching valves SV₁-SV₄ shown in FIG. 3, which are designed without check valves.

FIG. 4B shows a schematic representation of the actuation system according to FIG. 4 with a 3/2-way valve US instead of the 2/2-way valve MVₜ, whereby a hydraulic connection to the reservoir VB can be realized via the 3/2-way valve US for pressure reduction.

FIG. 5 shows a switching position of the 3/2-way valve PD1 when the pre-stroke working chamber VH of the double-stroke piston DHK is connected to the brake circuit BK to increase the pressure.

FIG. 5A shows a switching position of the de-energized 3/2-way valve PD1 or PD2.

FIG. 5B shows a switching position of the 3/2-way valve PD2 when connecting the return stroke working chamber RH of the double-stroke piston DHK to the brake circuit BK to increase pressure.

FIG. 6 shows a temporal sequence during the switchover of the double-stroke piston DHK from forward stroke to return stroke during pressure build-up.

FIG. 6A shows valve switching positions during forward stroke and return stroke of the double-acting piston during pressure build-up from 0 bar.

FIG. 6B shows a temporal sequence of the double-stroke piston DHK switching from forward stroke to return stroke during pressure reduction.

FIG. 6C shows a time sequence for switching the DHK double-acting piston from forward stroke to return stroke with the US 3/2-way valve during pressure build-up.

FIG. 6D shows a temporal sequence when switching the DHK double-stroke piston from forward stroke to return stroke with the 3/2-way valve US as the switching device during pressure reduction.

### DETAILED DESCRIPTION OF THE EXAMPLE EMBODIMENTS

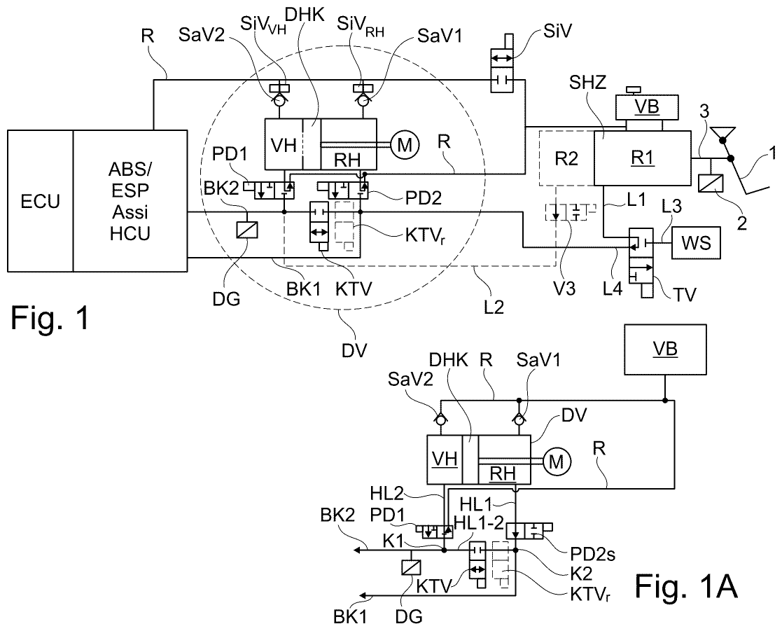

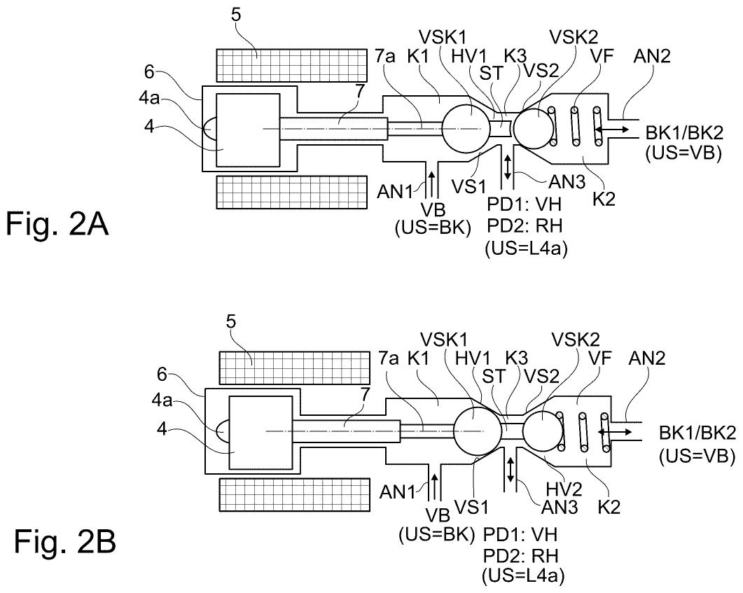

FIG. 1 shows a system with a master brake cylinder HZ, e.g., a single master brake cylinder SHZ with one working chamber R1 or a tandem master brake cylinder THZ with two working chambers R1 and R2, together with a reservoir VB and a pedal travel sensor 2. All valves are shown in FIG. 1 in their de-energized state. In the case of the single master cylinder SHZ, a hydraulic line L1 leads via a 3/2-way valve TV, shown in its de-energized state, and via hydraulic line L4 to the pressure supply device DV and to the brake circuit BK1. When the 3/2-way valve TV is energized, the working chamber R1 is connected to the path simulator WS via the hydraulic line L1, the 3/2-way valve TV, and the hydraulic line L3. Hydraulic line L4 leads directly to the 3/2-way valve PD2 and via the circuit isolating valve KTV and, if necessary, via an additional redundant circuit isolating valve KTVᵣ to the brake circuit BK2. The pre-stroke working chamber VH of the pressure supply device DV is connected to the second brake circuit BK2 via the energized 3/2-way valve PD1 and to the reservoir VB via the return line R via the de-energized 3/2-way valve PD1. In addition, safety valves SiV_{VH} and SiV_{RH} can be used as double faults in the event of a leaky valve seat of the suction valve SaV1 or SaV2 and a leak in the DHK seal. Alternatively, both connections from the working chambers VH and RH of the double-stroke piston DHK to the reservoir VB can be switched via the two safety valves SiV_{VH} and SiV_{RH}. The 3/2-way valves PD1 and PD2 are the main components of the double-acting piston DHK, which are described in detail in FIGS. 2A and 2B. The two brake circuits BK1 and BK2 of the pressure supply device DV lead to the hydraulic unit HCU for ABS, ESP, and assistance functions, which are supplied with pressure by the pressure supply device DV. The pressure supply device DV can be used not only to build up pressure, but also to reduce pressure.

FIG. 1a shows an alternative example embodiment of the actuating system according to FIG. 1 without master brake cylinder SHZ/THZ, wherein the second 3/2-way valve PD2 is replaced by a 2/2-way valve to reduce costs, so that the return stroke working chamber RH can no longer be connected to the reservoir VB via a solenoid valve, but with functional limitations, e.g., pressure reduction during return stroke and 3/2-way valve PD1 shown without power.

FIG. 2A shows a schematic representation of a 3/2-way valve PD1 or PD2 according to an example embodiment of the present invention for the braking system according to an example embodiment of the present invention. The 3/2-way valve PD1 or PD2 has an excitation winding 5 arranged around a magnetic yoke 6, in which the magnetic armature 4 can be adjusted in the axial direction relative to the connecting bolt 7, 7a. A stop element 4a is arranged at the left end of the magnetic armature 4, which abuts against the inner wall of the magnetic yoke 6 in the de-energized switching state of the 3/2-way valve PD1 or PD2 shown in FIG. 2A. The first valve closing body VSK1 is arranged at the right end of the connecting bolt 7, 7a and is firmly connected to the connecting bolt end 7a. The first valve closing body VSK1 acts together with the first valve seat VS1, which may be part of the magnetic yoke 6. The magnetic yoke 6 defines a first valve chamber K1 in the area of the connecting bolt section 7a, which is connected via a hydraulic channel to the first valve connection AN1 for connecting the reservoir VB.

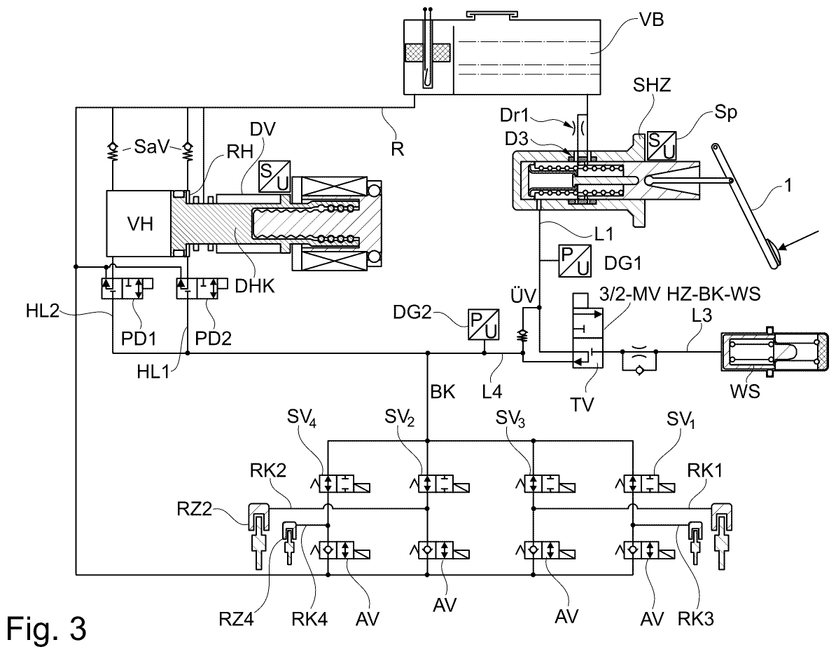

The 3/2-way valve PD1 or PD2 also has a second valve chamber K2 in which the valve spring VF and a second valve closing body VSK2 are arranged with the valve seat VS2 with the cross-sectional area that is important for pressure build-up and determines the TTL. The second valve chamber K2 is connected via a hydraulic channel to the second valve connection AN2, to which the brake circuit BK2 or BK1 is connected. The left side of the second valve chamber K2 defines the second valve seat VS2 of the 3/2-way valve PD1 or PD2, which interacts with the second valve closing body VSK2. A third valve chamber K3 is arranged between the two valve seats VS1 and VS2 and is connected to the third valve connection AN3 with the forward stroke working chamber VH or rear stroke working chamber RH. A tappet ST is molded or attached to the side of the first valve closing body VSK1 facing away from the connecting bolt 7, 7a. The tappet is dimensioned in such a way that it extends through the first valve seat VS1 and the third valve chamber K3 and, when the 3/2-way valve PD1 or PD2 is energized, its free end can act on the second valve closing body VSK2. Depending on the overall design, the valve connection AN2 of the 3/2-way valve PD1 or PD2 may also be connected only to a brake circuit BK, see, for example, FIG. 3.

FIG. 2B shows the “energized” state of the 3/2-way valve PD1 or PD2, in which the anchor 4 is moved to the right by the magnetic field of the excitation coil 5, causing the first valve closing element VSK1 to press to the right and, with the tappet ST, against the second valve closing element VSK2, pushing it away from the second valve seat VS2 against the spring force of the valve spring VF, whereby the pressure supply device DV is now connected to the brake circuit BK1/BK2. The hydraulic connection HV2 between the second valve chamber K2 and the third valve chamber K3 is open, connecting the forward stroke working chamber VH and the return stroke working chamber RH of the pressure supply device to the brake circuit BK2 and BK1, respectively, and the hydraulic connection HV1 between the first valve chamber K1 and the third valve chamber K3 is closed, and the reservoir VB is disconnected.

The valve spring VF is dimensioned such that, when the 3/2-way valve PD1 or PD2 is de-energized, the solenoid anchor 4 is reliably set back and the valve closing body VSK2 is pressed securely against the second valve seat VS2 to form a seal.

FIG. 3 shows a brake system as previously known from PCT/EP 2022/059069, which includes four wheel circuits RK1-RK4, the reservoir VB, a single master brake cylinder SHZ with the third seal D3 and throttle Dr1, and pedal travel sensors Sp. In the de-energized state, the 3/2-way isolation valve TV connects the hydraulic line L1 to the hydraulic line L4, and thus the single master brake cylinder SHZ to the brake circuit BK, and blocks the connection of the hydraulic line L1 to the hydraulic line L3, thereby blocking the connection from the single master brake cylinder SHZ to the travel simulator WS. When energized, the 3/2-way isolating valve TV connects the hydraulic line L1 to the hydraulic line L3, thereby connecting the single master brake cylinder SHZ to the travel simulator and blocking the connection between hydraulic line L1 and hydraulic line L4, which blocks the connection from the single master brake cylinder SHZ to the brake circuit BK. A pressure sensor DG1 is located in the hydraulic line L1 connecting the single master brake cylinder SHZ to the 3/2-way isolating valve TV, which is used to monitor the pedal characteristics. Together with the pedal travel sensors Sp, it also monitors the single master brake cylinder SHZ, the travel simulator WS, and the 3/2-way isolating valve TV, whereby the current values of the pedal travel sensors Sp and the pressure sensor DG1 are constantly compared with the values stored in the electronic control unit ECU. The 3/2-way isolating valve TV is connected to the brake circuit BK and to the pressure supply device DV and the 3/2-way valves PD1 and PD2 via the hydraulic line L4. The brake circuit BK is in turn connected via the switch valves SV₁-SV4, which are modified standard ABS inlet valves EV without check valve RV in the SVᵢ₌₁₋₄ version, and via the hydraulic lines of the wheel circuits RK1-RK4 to the wheel brake cylinders RZ1-RZ4. In the line from the switch valve SV1-SV4 to the wheel brake cylinder RZ1-RZ4, an outlet valve AV is provided in each case for pressure reduction, in particular for the ABS function. The switch valves SVᵢ₌₁₋₄ are of great importance for the four-circuit function of the wheel circuits RK1-RK4, as described in particular in FIG. 2 of PCT/EP 2022/059069.

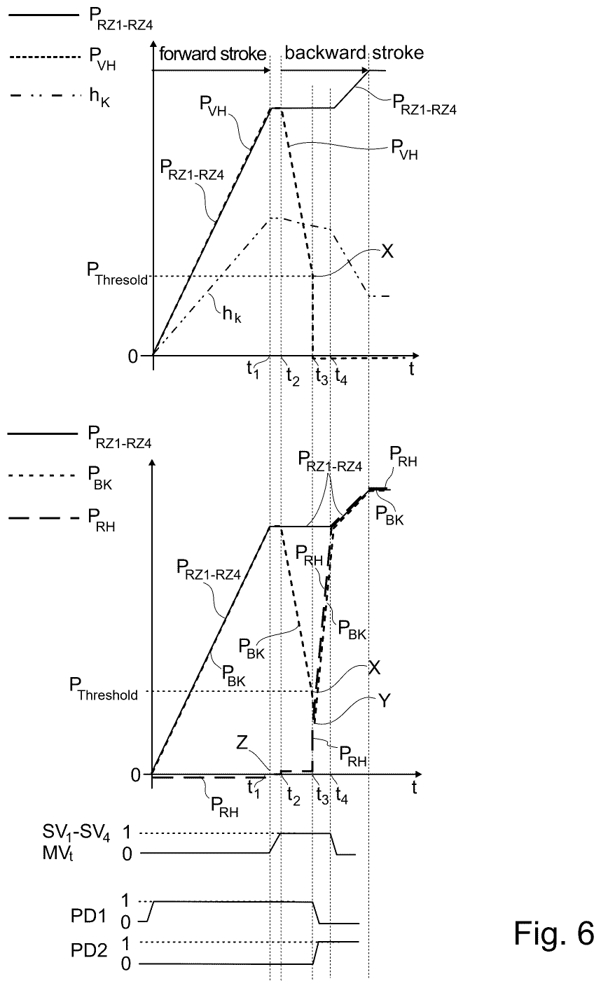

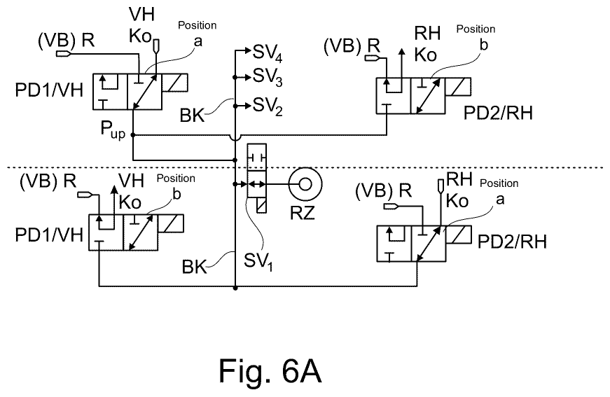

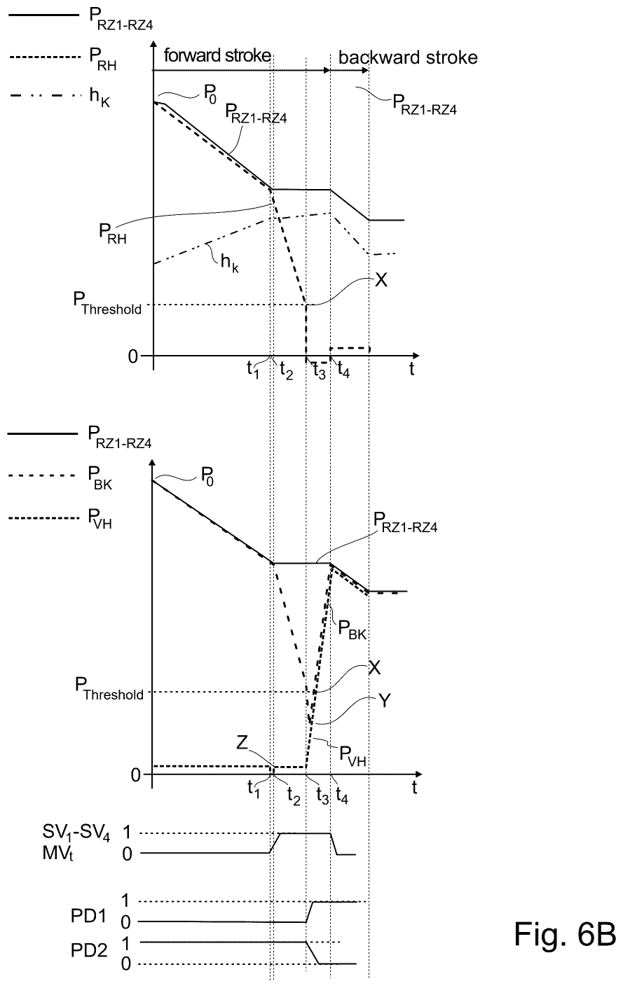

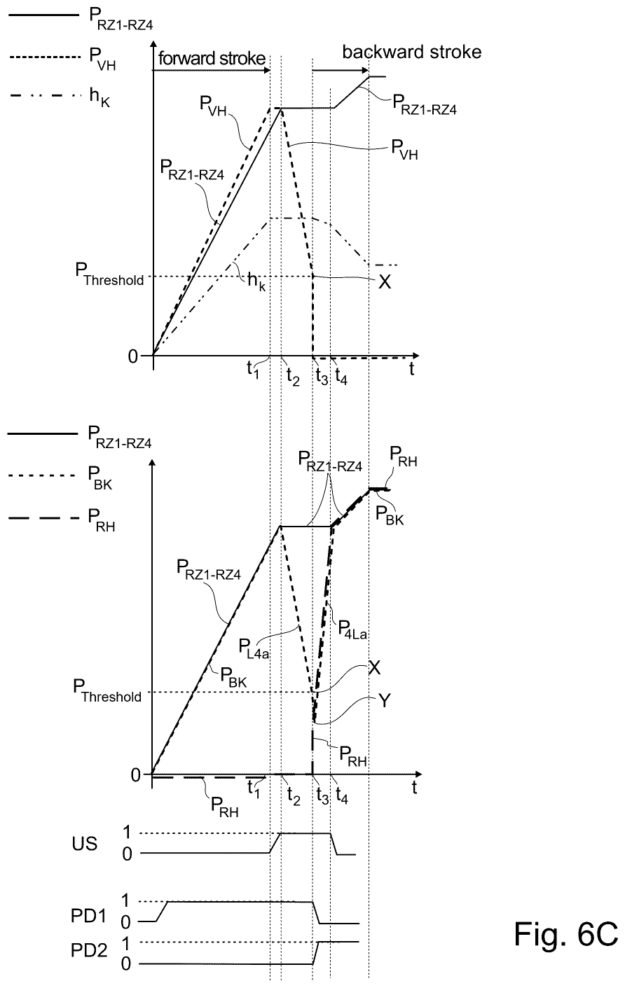

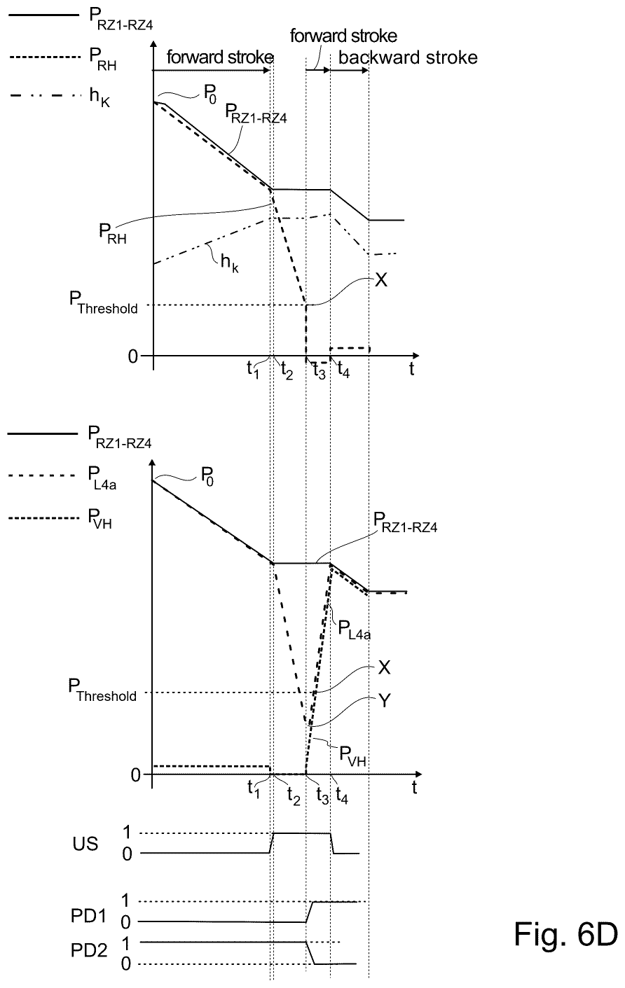

The four-circuit system with its four switching valves SV₁-SV₄ without respective check valves is of great importance for the double-stroke piston valve circuit according to an example embodiment of the present invention with its 3/2-way valves PD1 and PD2. FIGS. 6, 6A, 6B, and 6C illustrate in more detail the various switching strategies and process strategies for switching the 3/2-way valves PD1 and PD2, each with a large flow cross-section, in conjunction with the forward stroke working chamber VH or the return stroke working chamber RH and their connection to the brake circuit BK. The large valve opening cross-section is necessary in order to achieve small time-to-lock values, known as TTL values, of, e.g., 150 ms. With this switching strategy, an additional volume intake/volume change of the wheel brake cylinders RZ1-RZ4 must be avoided when switching the 3/2-way valves PD1 and PD2. The switching valve SVᵢ₌₁₋₄, which separates the wheel circuits RK1-RK4, is suitable for this purpose. This allows the switching strategy for the 3/2-way valves PD1 and PD2, which is described in more detail later in FIGS. 6, 6A, 6B, 6C, and 6D, to be successfully used.

Many variants are conceivable for the 3/2-way isolation valve TV, depending on the high safety requirements, e.g., failure of the electronic control unit ECU at high pressure in the master brake cylinder HZ and high or low pressure in the brake circuit BK, in which case a connection from the master brake cylinder HZ to the brake circuit BK is always necessary in the event of failure of the pressure supply device DV or electronic control unit ECU. One of the variants is shown here, with a pressure relief valve ÜV.

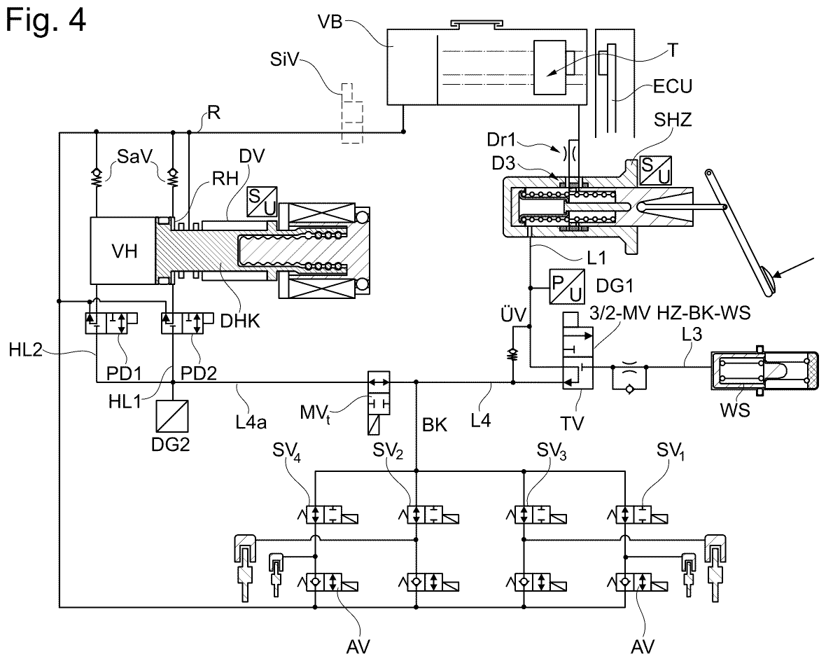

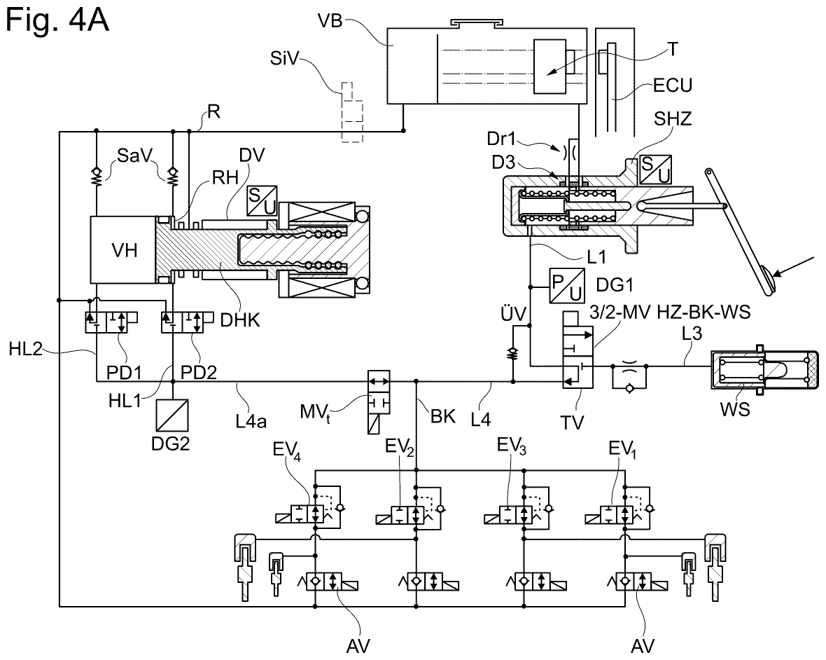

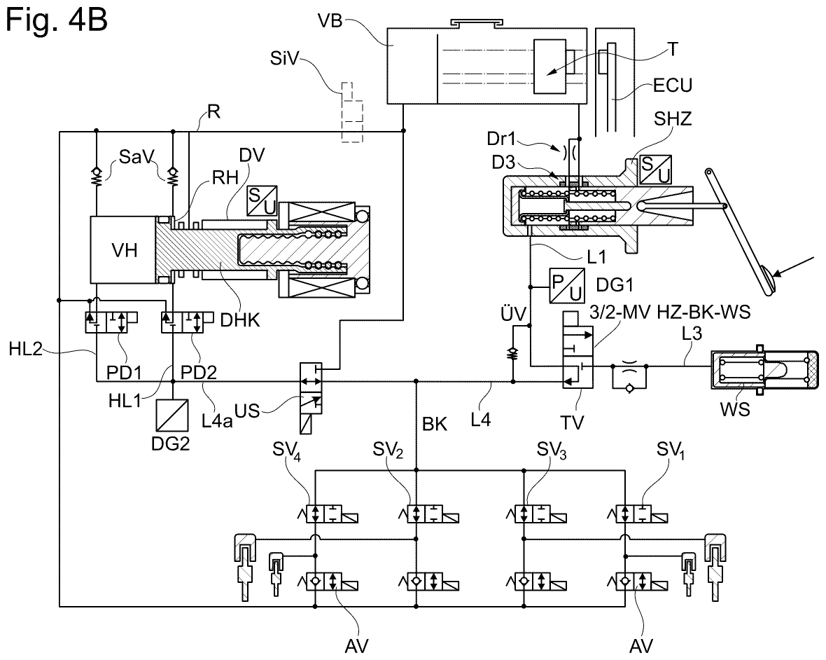

FIG. 4 shows another concept based on FIG. 3. Here, in addition to the switching valves SV1-SV4, an isolation valve MVₜ is used, which disconnects the brake circuit BK from the 3/2-way valves PD1 and PD2 in the switching strategy of the 3/2-way valves PD1 and PD2. Optionally, standard ABS inlet valves with check valves EV₁-EV₄ can be used instead of the switching valves SV₁-SV₄, as shown in FIG. 4A. With this concept, too, the four-circuit system with the four switching valves SV₁-SV₄ without check valves, e.g., in the event of a fault in the control of an outlet valve AV, the pressure reduction function of the failed outlet valve AV in ABS operation can be replaced or taken over by the switching valves SV₁₋₄ and the pressure supply device DV.

The safety valve SiV described in FIG. 1 can be used in the return line R from the pressure supply device DV to the reservoir VB.

Furthermore, it is advisable to adapt the electronic control unit ECU to the reservoir VB by integrating the brake fluid level sensor into the electronic control unit ECU instead of having it as a separate component with a cable set.

FIG. 4B shows another concept based on FIGS. 4 and 4A. Here, instead of the shut-off valve MVₜ a 3/2-way valve US can be used for the switching strategy of the 3/2-way valves PD1 and PD2, which disconnects the connection from the brake circuit BK to the 3/2-way valves PD1 and PD2 and connects the 3/2-way valves PD1 and PD2 to the reservoir VB. Optionally, standard ASV inlet valves EV EV₄ with check valves can also be used in this brake system arrangement instead of the switching valves SV1-SV4.

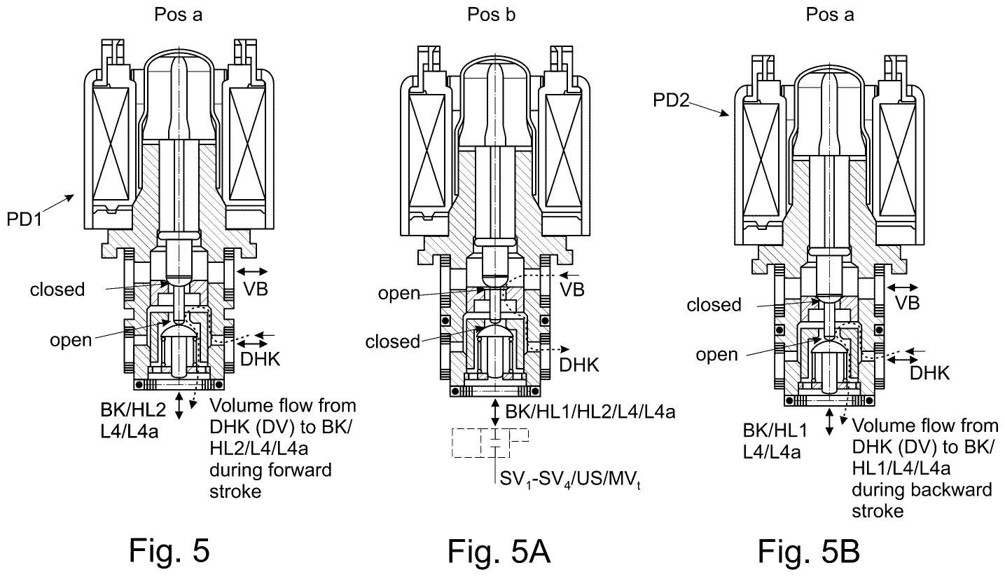

FIGS. 5, 5A, and 5B show a possible design for a PD1 or PD2 valve and its various switching positions. FIG. 5 shows the energized state of the 3/2-way valve PD1, in which the pre-stroke working chamber VH is connected to the brake circuit BK (position a). Pre-stroke of the double-stroke piston DHK then causes a volume flow through the 3/2-way valve PD1 and a pressure build-up in the brake circuit BK. FIG. 5A shows the de-energized state of the 3/2-way valve PD1 or PD2, in which the pre-stroke working chamber VH is connected to the reservoir VB, or in which the return stroke working chamber RH is connected to the reservoir VB (position b). FIG. 5B shows the volume flow from the return stroke working chamber RH to the brake circuit BK via the 3/2-way valve PD2 during pressure build-up or pressure reduction when the 3/2-way valve PD1 is also switched (position a), by the return stroke of the double-stroke piston DHK, whereby the 3/2-way valve PD2 is in its switching position “a” like the valve PD1 shown in FIG. 5.

To build up pressure Pᵤₚ through forward stroke of the double-acting piston DHK (FIG. 5), the 3/2-way valve PD1 is energized (position a), while the 3/2-way valve PD2 can either be energized (position a) or remain de-energized (position b). If the 3/2-way valve PD2 is energized (position a), a portion of the pre-stroke volume of the double-stroke piston DHK flows from the pre-stroke working chamber VH through the 3/2-way valve PD1 through the brake circuit BK and through the 3/2-way valve PD2 into the return stroke working chamber RH, which means that only a lower motor torque is required to adjust the double-stroke piston DHK than if the 3/2-way valve PD2 remains de-energized. This type of control has the advantage of enabling motor downsizing. This switching combination, in which both valves PD1 and PD2 are in position a), is therefore preferably used for high pressures P_{BK} in the brake circuit BK. If the 3/2-way valve PD2 remains de-energized (position b), the entire stroke volume of the double-stroke piston DHK flows from the pre-stroke working chamber VH into the brake circuit BK, and the pressure in the brake circuit BK is then higher than when the 3/2-way valve PD2 is energized (position a). This switching combination “PD1 in position a and PD2 in position b” is therefore preferably used for low TTL values.

To build up pressure Pᵤₚ through the return stroke of the double-acting piston DHK, the 3/2-way valve PD1 is de-energized (position b in FIG. 5A), while the 3/2-way valve PD2 is energized (position a in FIG. 5B). The return stroke volume of the double-acting piston DHK then flows from the return stroke working chamber RH via the 3/2-way valve PD2 into the brake circuit BK. At the same time, volume is drawn in from the reservoir VB through the suction valve SaV of the forward stroke working chamber VH and through the 3/2-way valve PD1.

To reduce pressure P_{down} by the return stroke of the double-acting piston DHK, the 3/2-way valve PD1 is energized (position a), while the 3/2-way valve PD2 can either be energized (position a) or remain de-energized (position b). If the 3/2-way valve PD2 is energized (position a), the return stroke volume of the double-stroke piston DHK flows from the return stroke working chamber RH through the 3/2-way valve PD2, through the brake circuit BK and the 3/2-way valve PD1 into the forward stroke working chamber VH, which means that only a smaller motor torque is required to adjust the double-stroke piston DHK, in contrast to the valve control in which the 3/2-way valve PD2 remains de-energized (motor downsizing). This switching combination “PD1 and PD2 both in position a” is therefore preferably used for high pressures P_{BK} in the brake circuit BK. If, on the other hand, the 3/2-way valve PD2 remains de-energized (position b), the entire return stroke volume of the pre-stroke working chamber VH of the double-stroke piston DHK flows from the brake circuit BK into the pre-stroke working chamber VH, and the pressure in the brake circuit BK is then lower than when the 3/2-way valve PD2 is energized (position a). Volume then flows from the return stroke working chamber RH into the reservoir VB via the 3/2-way valve PD2. This switching combination “PD1 in position a and PD2 in position b” is therefore preferably used for low pressures in the brake circuit P_{BK}.

To reduce the pressure P_{down} by the forward stroke of the double-acting piston DHK, the 3/2-way valve PD1 is de-energized (position b), while the 3/2-way valve PD2 is energized (position a). The return stroke volume of the return stroke working chamber RH of the double-stroke piston DHK then flows from the brake circuit BK via the 3/2-way valve PD2 into the return stroke working chamber RH. At the same time, volume flows from the forward stroke working chamber VH through the 3/2-way valve PD1 into the reservoir VB.

If both 3/2-way valves PD1 and PD2 are de-energized, no volume is conveyed from the working chambers VH and RH of the double-stroke piston DHK into or out of the brake circuit BK during forward or return stroke. As already mentioned, the stroke of the double-acting piston is therefore referred to as a no-load stroke. The no-load stroke can be used to position the double-acting piston DHK without conveying volume into or out of the brake circuit BK. This is used in the event of a fault in the pressure supply device DV, e.g., if the DHK piston seal is leaking.

FIG. 6 shows the aforementioned switching strategy of the 3/2-way valves PD1 and PD2 for the system diagram in FIG. 3 when switching from double-stroke piston forward stroke to double-stroke piston reverse stroke during pressure build-up P from 0 bar, with the time sequence of the pressure in the brake circuit P_{BK}, the pressure P_{RH} in the return stroke working chamber RH, the pressure P_{VH} in the advance stroke working chamber VH, the pressure in the wheel brake cylinders P_{RZ1-RZ4}, the piston stroke hₖ, the signals from the switching valves SV₁-SV₄, and the signals from the 3/2-way valves PD1 and PD2, where signal=0 means that the valve is de-energized and signal=1 means that the valve is energized. FIG. 6 also shows the switching strategy for the system diagram in FIG. 4, except that instead of the switch valves SV₁-SV₄, only the disconnect valve MVₜ is switched. The switch valves SV₁-SV₄ remain de-energized (open) throughout the entire process.

When using the shut-off valve MVₜ, standard ABS inlet valves with check valves EV₁-EV₄ can also be used instead of the switching valves SV₁-SV₄, whereby the time sequences shown in FIG. 6 remain unchanged.

At time t=0, the pre-stroke of the double-acting piston DHK is h_{K}=0 mm. If the 3/2-way valve PD1 is energized (signal=1, position a, see FIG. 5), the 3/2-way valve PD2 is de-energized (signal=0, position b, see FIG. 5A), and the switching valves SV SV₄ (or shut-off valve MVₜ) are de-energized (signal=0), i.e., the switching valves SV₁-SV₄ (or the shut-off valve MVₜ) are open, the pressure in the forward stroke working chamber VH P_{VH}=0 bar, the pressure in the return stroke working chamber RH P_{RH}=0 bar, the pressure in the brake circuit BK P_{BK}=0 bar, and the pressure in the wheel brake cylinders RZ1-RZ4 P_{RZ1-RZ4}=0 bar.

From time t=0, the forward stroke of the double-stroke piston DHK begins with stroke h_{K}, and thus the brake pressure build-up in the forward stroke working chamber VH P_{VH}, in the brake circuit BK P_{BK} and in the wheel brake cylinders RZ1-RZ4, P_{RZ1-RZ4}, whereby the pressure in the return stroke working chamber RH P_{RH} is adjusted to suction pressure during suction from the reservoir VB via the suction valve SaV and via the de-energized valve PD2, which connects the return stroke working chamber RH to the reservoir VB.

At time t=t₁, the double-stroke piston movement switches from forward stroke to reverse stroke. The movement of the double-stroke piston DHK is initially stopped, i.e., the stroke of the double-stroke piston hₖ remains constant, causing the pressure P_{VH} in the forward stroke working chamber VH, the pressure P_{BK} in the brake circuit BK, and the pressure P_{RZ1-RZ4} in the wheel brake cylinders to remain constant. Also at time t=t1 or shortly before or after, the switching valves SV₁-SV4 and the isolation valve MVₜ are energized, i.e., the valves SV₁-SV₄ and the isolation valve MVₜ are closed and thus disconnected from the pressure supply. Because no more volume is being sucked in, the pressure in the return stroke working chamber RH rises to P_{RH}=0 bar.

At time t=t₂, the switching valves SV₁-SV₄ and the isolation valve MVₜ are closed. Now the double-stroke piston DHK begins to reverse its movement with a slight return stroke h_{K}. The pressure P_{VH} in the forward stroke working chamber VH and the pressure P_{BK} in the brake circuit BK or in the hydraulic line L4a (FIG. 4) decrease very quickly because, on the one hand, the hydraulic system is isolated from the hydraulic circuit BK by the closed switching valves SV₁-SV₄ and the energized 3/2-way isolation valve TV, which disconnects the single master brake cylinder SHZ and brake circuit BK, or by the closed isolation valve MVₜ. Due to the return stroke h_{K} of the double-stroke piston DHK, volume flows from the return stroke working chamber RH through the de-energized 3/2-way valve PD2 (position b, see FIG. 5A) to the reservoir VB, and the pressure in the return stroke working chamber RH rises to the back pressure P_{RH}=Zbar of the 3/2-way valve PD2.

At time t=t₃, the pressure P_{BK}=X bar, e.g., X bar=20 bar, is reached in the brake circuit BK or in the hydraulic line L4a (FIG. 4), at which the magnetic force of the 3/2-way valve PD2 is sufficient to switch the valve, whereby the pressure P_{BK} in the brake circuit BK or in the hydraulic line L4a (FIG. 4) is measured with the pressure sensor DG2 or estimated based on the motor current. Up to the pressure P_{threshold(value)}, where P_{threshold}≤Xbar, whereby in FIG. 6 it is assumed that P_{threshold}=X bar, the pressure must therefore be reduced so that, with the corresponding design of the 3/2-way valve PD1, PD2 with a large valve seat or large flow cross-sectional area, the force of the valve spring is sufficient to switch the 3/2-way valve PDA, PD2. At time t=t₃, the power supply to the 3/2-way valve PD1 is switched off so that it reaches position b (see FIG. 5B), and the connection between the brake circuit BK or hydraulic line L4a (FIG. 4) and the pre-stroke working chamber VH is disconnected, and the connection between the pre-stroke working chamber VH and the reservoir VB is established via the 3/2-way valve PD1. The pressure P_{VH} in the pre-stroke working chamber VH at time t=t₃ drops to suction pressure due to the continued slight return stroke of the double-stroke piston DHK. At time t=t₃, the 3/2-way valve PD2 is also energized and switched to position a (see FIG. 5B), connecting the brake circuit BK, or the hydraulic line L4a (FIG. 4), to the return stroke working chamber RH, the pressure P(_{RH)} in the return stroke working chamber RH and the pressure P_{BK} in the brake circuit BK or in the hydraulic line L4a (FIG. 4) are equalized to a value Ybar, which lies between the dynamic pressure P_{RH}=Z bar in the return stroke working chamber RH and the pressure P_{BK}=X bar in the brake circuit BK or in the hydraulic line L4a (FIG. 4), P_{RH}=P_{BK}=Y bar. Due to the continued slight return stroke hₖ of the double-stroke piston DHK, the pressure P_{BK} in the brake circuit BK or in the hydraulic line L4a (FIG. 4) rises again very quickly due to the high stiffness of the hydraulic system mentioned above.

After the pressure in the brake circuit BK or in the hydraulic line L4a (FIG. 4), P_{BK}, has reached the pressure P_{RZ1-RZ4} in the wheel cylinders at time t=t₄, P_{BK}=P_{RZ1-RZ4}, the current of the switching valves SV₁-SV₄ and the isolation valve MVt is switched off. The return stroke movement hK of the double-stroke piston DHK continues at time t=t₄, now in accordance with the pressure increase specification, which is specified by the driver, for example, and measured by the pedal travel sensor Sp or derived from the measurement, whereby the pressures P_{BK}, P_{RH}, P_{RZ1-RZ4} in the wheel brake cylinders, in the brake circuit BK, and in the return stroke working chamber RH follow the driver's wishes. The pressure P_{VH} in the advance stroke working chamber VH remains at suction pressure level during suction from the reservoir VB.

As already mentioned, the high hydraulic stiffness of the system must be taken into account, so that even small changes in the stroke h_{K} of the double-stroke piston result in a pressure change as long as the switch valves SV₁-SV₄ and the shut-off valve MVₜ are energized (closed) and the 3/2-way shut-off valve TV is energized, thereby disconnecting the connection between the master brake cylinder HZ and the brake circuit BK. The switchover time of the pressure build-up, the pressure curve, and the noise level can be optimized by overlapping the valve switching times with the corresponding piston stroke h_{K} of the double-stroke piston DHK.

FIG. 6A shows the corresponding valve circuit for the switching times and controls described in FIG. 6. The upper half of FIG. 6A, above the dashed line, shows an example of the circuit and the volume flows of the 3/2-way valves PD1 and PD2 during pressure build-up from 0 bar due to the forward stroke of the double-stroke piston DHK, whereby, deviating from this, the 3/2-way valve PD2 can also be energized to reduce the motor torque required for pressure build-up. The lower half of FIG. 6A shows the circuit of the 3/2-way valves PD1 and PD2 during pressure build-up due to the return stroke of the double-stroke piston DHK.

FIG. 6B shows the aforementioned switching strategy of the 3/2-way valves PD1 and PD2 for the system diagram in FIG. 3 when switching from double-stroke piston forward stroke to double-stroke piston return stroke during pressure reduction, with the time sequence from pressure P_{BK} in the brake circuit, from pressure P_{RH} in the return stroke working chamber RH, the pressure P_{VH} in the forward stroke working chamber VH, the pressure P_{RZ1-RZ4} in the wheel brake cylinder, the piston stroke hₖ, the signals from the switching valves SV₁-SV₄, and from the signals of the 3/2-way valves PD1 and PD2, where signal=0 means that the valve is de-energized and signal=1 means that the valve is energized. FIG. 6B also shows the switching strategy for the system diagram in FIG. 4, but only the isolating valve MVₜ is switched instead of the switching valves SV₁-SV₄, which remain de-energized (open) throughout the entire process. As already explained above, in this example embodiment, using the valve MVₜ, the switching valves SV₁-SV₄ can be replaced by standard ABS inlet valves with check valves EV₁-EV₄. This does not change the time sequences shown and explained.

At time t=0, the 3/2-way valve PD2 is energized (signal=1, position a, see FIG. 5), the 3/2-way valve PD1 is de-energized (signal=0, position b, see FIG. 5A), the switching valves SV₁-SV₄ and the shut-off valve MVₜ are de-energized (signal=0), i.e., the switching valves SV₁-SV₄ (or the shut-off valve MVₜ) are open, and the pressure in the forward stroke working chamber VH P_{VH}=0 bar, the pressure in the return stroke working chamber RH P_{RH}=P₀ bar, the pressure in the brake circuit BK P_{BK}=P₀ bar, and the pressure in the wheel brake cylinders RZ1-RZ4 P_{RZ1-RZ4}=P₀ bar.

From time t=0, the double-stroke piston DHK begins its forward stroke with stroke h_{K}, and thus the brake pressure reduction in the return stroke working chamber RH P_{RH}, in the brake circuit BK P_{BK} and in the wheel brake cylinders RZ1-RZ4, P_{RZ1-RZ4} where the pressure in the forward stroke working chamber VH P_{VH} adjusts to dynamic pressure during delivery to the reservoir VB via the de-energized valve PD1, which connects the forward stroke working chamber VH to the reservoir VB.

At time t=t₁, the double-stroke piston movement is switched from forward stroke to reverse stroke. The movement of the double-stroke piston is stopped, i.e., the stroke of the double-stroke piston hₖ remains constant, whereby the pressure P_{RH} in the reverse stroke working chamber RH, the pressure P_{BK} in the brake circuit BK and the pressure P_{RZ1-RZ4} in the wheel brake cylinders remain constant, and the switching valves SV₁-SV₄ and the isolating valve MVₜ are energized, i.e., the valves SV₁-SV₄ and the isolating valve MVₜ are closed. Because no more volume is delivered from the pre-stroke working chamber VH to the reservoir VB via the de-energized valve PD1, the pressure in the pre-stroke working chamber VH drops to P_{VH}=0 bar.

At time t=t₂, the switching valves SV₁-SV₄ are closed, the isolation valve MVₜ is closed, and the pressure P_{RZ1-RZ4} in the wheel brake cylinders remains constant. Now the preliminary stroke h_{K} of the double-stroke piston DHK continues slightly. During this process, the pressure P_{RH} in the return stroke working chamber RH and the pressure in the brake circuit P_{BK} or in the hydraulic line L4a (FIG. 4) decrease very rapidly because the hydraulic system is very rigid due to the energized 3/2-way isolation valve TV, which disconnects the single master brake cylinder SHZ from the brake circuit BK, and due to the closed switching valves SV₁-SV₄ and the closed isolation valve MVₜ. Due to the pre-stroke h_{K} of the double-stroke piston DHK, volume flows from the pre-stroke working chamber VH through the de-energized 3/2-way valve PD1 (position b, see FIG. 5A) to the reservoir VB, and the pressure in the pre-stroke working chamber VH rises to the back pressure P_{VH}=Z bar of the 3/2-way valve PD1.

At time t=t₃, the pressure P_{BK}=X bar, e.g., X bar=20 bar, is reached in the brake circuit BK or in the hydraulic line L4a (FIG. 4), at which the magnetic force of the 3/2-way valve PD1 is sufficient to switch the valve, whereby the pressure P_{BK} in the brake circuit BK or in the hydraulic line L4a (FIG. 4) is measured with the pressure transducer DG2 or estimated based on the motor current. At time t=t₃, the power supply to the 3/2-way valve PD2 is switched off so that it reaches position b (see FIG. 5B), and the connection between the brake circuit BK or hydraulic line L4a (FIG. 4) and the return stroke working chamber RH is disconnected, and the connection between the return stroke working chamber RH and the reservoir VB is established via the 3/2-way valve PD2, and the pressure P_{RH} in the return stroke working chamber RH drops to suction pressure at time t=t₃ due to the continued slight forward stroke of the double-stroke piston DHK. At time t=t₃, the 3/2-way valve PD1 is energized and switched to position a (see FIG. 5B), thereby connecting the brake circuit BK or the hydraulic line L4a (FIG. 4) to the forward stroke working chamber VH, the pressure in the forward stroke working chamber VH P_{VH} and the pressure in the brake circuit BK or in the hydraulic line L4a (FIG. 4), P_{BK}, are thereby equalized to a value Ybar between the dynamic pressure P_{VH}=Z bar in the pre-stroke working chamber VH and the pressure P_{BK}=X bar in the brake circuit BK or in the hydraulic line L4a (FIG. 4), P_{VH}=P_{BK}=Y bar. Due to the continued slight forward stroke of the double-stroke piston DHK, the pressure in the forward stroke working chamber, in the brake circuit BK, or in the hydraulic line L4a (FIG. 4), P_{BK} rises again very quickly due to the high rigidity of the hydraulic system mentioned above.

After the pressure in the brake circuit BK or in the hydraulic line L4a (FIG. 4), P_{BK}, has reached the pressure P_{RZ1-RZ4} in the wheel cylinders at time t=t₄, P_{BK}=P_{RZ1-RZ4} the current to valves SV₁-SV₄ or the shut-off valve MVₜ is switched off. The return stroke of the double-acting piston DHK h_{K} is initiated at time t=t₄, now in accordance with the pressure reduction specification, which is specified, for example, by the driver and measured by the pedal travel sensor Sp or derived from the measurement, whereby the pressures in the wheel brake cylinders P_{RZ1-RZ4}, in the brake circuit BK P_{BK} and in the pre-stroke working chamber VH P_{VH} are reduced in accordance with the driver's wishes. The pressure in the return stroke working chamber RH P_{VH} rises to the back pressure level when it is transferred from the return stroke working chamber to the reservoir VB.

FIG. 6C shows the aforementioned switching strategy of the 3/2-way valves PD1 and PD2 for the system diagram in FIG. 4B when switching from double-stroke piston forward stroke to double-stroke piston return stroke during pressure build-up from 0 bar, with the time sequence of the pressure in the hydraulic line L4a P_{L4a}, the pressure P_{RH} in the return stroke working chamber RH, the pressure P_{VH} in the advance stroke working chamber VH, the pressure in the wheel brake cylinders P_{RZ1-RZ4}, the piston stroke hₖ, the signal from the 3/2-way valve US, and the signals from the 3/2-way valves PD1 and PD2, where signal=0 means that the valve is de-energized and signal=1 means that the valve is energized. Both the switching valves SV₁-SV₄ and the optional standard ABS inlet valves with check valve EV₁-EV₄ remain de-energized (open) throughout the entire sequence.

The 3/2-way valve US is designed as shown in FIG. 2A (de-energized) and FIG. 2B (energized), whereby in the 3/2-way valve US, the hydraulic line L4 or the brake circuit BK is connected to connection AN1, hydraulic line L4a is connected to connection AN3, and the reservoir VB is connected to connection AN2. In the de-energized position, the 3/2-way valve US thus connects the hydraulic line L4a to the hydraulic line L4 or brake circuit BK. In the energized position, the 3/2-way valve US connects the hydraulic line L4a to the reservoir VB.

As already mentioned, for short TTL times, e.g., TTL=150 ms, the first hydraulic connection HV1 of the 3/2-way valve US (FIG. 2A) should have a large cross-sectional area. However, in the energized state (FIG. 2B), the pressure P(_{BK)} in chamber K1 can be high, e.g., P_{BK}=100 bar, while the pressure P_{L4a} in chamber K3 is low, e.g., P_{L4a}=Y bar. In order to open the 3/2-way valve US with this large pressure difference P_{BK}−P_{L4a}=100−Y bar and this large cross-sectional area of the hydraulic connection HV1 when switching to the de-energized state, a large force of the spring VF would be necessary. To reduce this required force of the spring VF, a switching strategy similar to that of the 3/2-way valves PD1 and PD2 is used to open the 3/2-way valve US by increasing the pressure P_{L4a} in chamber K3 so that the pressure difference P_{BK}−P_{L4a} reaches the small value Xbar, for example, P_{BK}−P_{L4a}=X bar, and the force of the spring is sufficient to switch the 3/2-way valve US to the de-energized state. Values between 0 bar and Xbar can be selected for the differential pressure P_{BK}−P_{L4a} for switching the 3/2-way valve US. The pressure Xbar thus represents a lower threshold value for which the valve spring must be designed, or the pressure must be reduced to at least this pressure so that the valve spring can switch the valve reliably. In FIG. 4C, for example, the 3/2-way valve US is only de-energized when the differential P_{BK}−P_{L4a}=0 bar, i.e. X=0, because the switching noise of the 3/2-way valve US is lowest at this point. The pressure P_{L4a} in chamber K3 can be generated with the aid of the pressure supply DV by a volume flow through the second hydraulic connection HV2, which results in a dynamic pressure.

The timing sequences and valve signals of the 3/2-way valves PD1 and PD2 are similar to those shown in FIG. 6. The timing sequence of the 3/2-way valve US is also similar to that of the 2/2-way valve MVₜ. The main exceptions are the piston stroke sequence h_{K} and the switching strategy of the 3/2-way valve US. Therefore, this section focuses primarily on the piston stroke sequence h_{K} and the switching of the 3/2-way valve US.

At time t=t₁, the switchover of the double-stroke piston movement from forward stroke to return stroke is initiated. The movement of the double-stroke piston DHK is stopped, i.e. the stroke hₖ of the double-stroke piston remains constant, as a result of which the pressure P_{VH} in the forward stroke working chamber VH, the pressure in the brake circuit BK P_{BK} and the pressure P_{RZ1-RZ4} in the wheel brake cylinders remain constant.

At time t=t₁, the 3/2-way valve US is also energized, i.e., the connection between the hydraulic lines L4a and L4 or brake circuit BK is interrupted, while the hydraulic line L4a is connected to the reservoir VB (see FIG. 2B).

By connecting the hydraulic line L4a to the reservoir VB at time t=t1 via the 3/2-way valve US, the pressure P_{VH} in the pre-stroke working chamber VH and the pressure in the hydraulic line L4a (FIG. 4A), P_{L4a} decrease very quickly because the hydraulic system is very rigid, on the one hand due to the separate connection between the hydraulic line L4a and the hydraulic line L4, and on the other hand due to the energized 3/2-way isolation valve TV, which disconnects the single master brake cylinder SHZ and the brake circuit BK. The second hydraulic connection HV2 (see FIG. 2B) or a downstream throttle that is not shown can therefore be selected with a very small cross-sectional area. Because the piston no longer moves, the pressure in the return stroke working chamber RH drops to P_{RH}=0 bar. A slight DHK piston return stroke can be initiated to accelerate the pressure drop in the hydraulic line L4a, which is not taken into account in the following.

At time t=t₃, the pressure of P_{L4a}=Xbar, e.g., Xbar=20 bar, at which the magnetic force of the 3/2-way valve PD2 is sufficient to switch the valve, whereby the pressure in the hydraulic line L4a (FIG. 4A) P_{L4a} is measured with the pressure sensor DG2 or estimated based on the motor current. At time t=t₃, the power supply to the 3/2-way valve PD1 is switched off so that it reaches position b (see FIG. 5B), and the connection between hydraulic line L4a (FIG. 4A) and pre-stroke working chamber VH is disconnected, and the connection between pre-stroke working chamber VH and reservoir VB is established via 3/2-way valve PD1, and the pressure in pre-stroke working chamber VH P_{VH} drops to 0 bar at time t=t₃.

At time t=t₃, the 3/2-way valve PD2 is also energized and switched to position a (see FIG. 5B), connecting the hydraulic line L4a (FIG. 4A) to the return stroke working chamber RH, the pressure in the return stroke working chamber RH P_{RH} and the pressure in the hydraulic line L4a (FIG. 4A), P_{L4a}, are thereby equalized to a value Ybar that lies between the pressure P(_{RH)}=0 bar in the return stroke working chamber RH and the pressure P(_{L4a)}=Xbar in the hydraulic line L4a (FIG. 4A), P(_{RH)}=P(_{L4a)}=Ybar. Due to the slight return stroke of the double-acting piston DHK that now follows, the pressure supply DV delivers brake fluid via the 3/2-way valve US to the reservoir VB and the pressure in the hydraulic line L4a (FIG. 4A), P_{L4a}, increases very quickly due to the back pressure via the second hydraulic connection HV2 of the 3/2-way valve US and the aforementioned high rigidity of the hydraulic system. Due to the slight return stroke of the double-acting piston h_{K}, the pressure in the pre-stroke working chamber VH P_{VH} reaches the suction pressure level when sucking from the reservoir VB.

After the pressure P_{L4a} in the hydraulic line L4a (FIG. 4A) has reached the pressure P_{RZ1-RZ4} in the wheel cylinders at time t=t₄, P_{L4a}=P_{RZ1-RZ4} the current of the 3/2-way valve US is switched off and the force of the spring of the 3/2-way valve US is sufficient to switch the valve to the de-energized state at a pressure difference P_{L4a}-P_{RZ1-RZ4}=0 bar. The return stroke movement of the double-stroke piston DHK h_{K} continues at time t=t₄, now in accordance with the specified pressure increase, which is specified, for example, by the driver and measured by the pedal travel sensor Sp or derived from the measurement, whereby the pressures in the wheel brake cylinders P_{RZ1-RZ4}, in the brake circuit BK P_{BK} and in the return stroke working chamber RH P_{RH} follow the driver's wishes. The pressure in the pre-stroke working chamber VH P_{VH} remains at suction pressure level during suction from the reservoir VB.

FIG. 6D shows the aforementioned switching strategy of the 3/2-way valves PD1 and PD2 for the system diagram in FIG. 4A when switching from double-stroke piston forward stroke to double-stroke piston return stroke during pressure reduction, with the time sequence of the pressure in the hydraulic line L4a P_{L4a}, the pressure P_{RH} in the return stroke working chamber RH, the pressure P_{VH} in the advance stroke working chamber VH, the pressure in the wheel brake cylinders P_{RZ1-RZ4}, the piston stroke hₖ, the signal from the 3/2-way valve US, and the signals from the 3/2-way valves PD1 and PD2, where signal=0 means that the valve is de-energized and signal=1 means that the valve is energized. Both the switching valves SV₁-SV₄ and the optional standard ABS inlet valves with check valve EV₁-EV₄ remain de-energized (open) throughout the entire sequence.

The timing sequences and valve signals of the 3/2-way valves PD1 and PD2 are similar to those shown in FIG. 6B. The timing control and switching of the 3/2-way valve US is also similar to the control of the 2/2-way valve MVₜ. The main exceptions are the piston stroke h_{K} and the switching strategy of the 3/2-way valve US. Therefore, the main focus here is on the piston stroke h_{K} and the switching of the 3/2-way valve US.

Pressure relief occurs at the energized 3/2-way valve PD2 (position a) and de-energized 3/2-way valve PD1 (position b), initially via the forward stroke of the double-acting piston DHK. At time t=t₁, the double-acting piston movement switches from forward stroke to return stroke. The movement of the double-acting piston DHK is stopped, i.e. the stroke of the double-acting piston hₖ remains constant, as a result of which the pressure P_{VH} in the return stroke working chamber RH, the pressure P_{BK} in the brake circuit BK and the pressure P_{RZ1-RZ4} in the wheel brake cylinders remain constant.

At time t=t₁, the 3/2-way valve US is energized, i.e., the connection between the hydraulic lines L4a and L4 or brake circuit BK is interrupted, while the hydraulic line L4a is connected to the reservoir VB via the valve US (see FIG. 2B).

By connecting the hydraulic line L4a to the reservoir VB at time t=t1 via the 3/2-way valve US, the pressure P_{RH} in the return stroke working chamber RH and the pressure P_{L4a} in the hydraulic line L4a (FIG. 4A) decrease very quickly because the hydraulic system is very rigid, on the one hand due to the separate connection between the hydraulic line L4a and the hydraulic line L4, and on the other hand due to the energized 3/2-way isolation valve TV, which disconnects the single master brake cylinder SHZ and the brake circuit BK. The second hydraulic connection HV2 (see FIG. 2B) or a downstream throttle that is not shown can therefore be selected with a very small cross-sectional area. Because the double-stroke piston DHK no longer moves, the pressure in the pre-stroke working chamber VH drops to P_{RH}=0 bar. To accelerate the pressure drop in the hydraulic line L4a, a slight DHK piston pre-stroke can be initiated to assist, which is not taken into account in the following.

At time t=t₃, the pressure in the hydraulic line L4a (FIG. 4A) reaches P_{L4a}=X bar, e.g., X bar=20 bar, is reached in the hydraulic line L4a (FIG. 4A), at which the magnetic force of the 3/2-way valve PD1 is sufficient to switch the valve, whereby the pressure in the hydraulic line L4a (FIG. 4A) P_{L4a} is measured with the pressure sensor DG2 or estimated based on the motor current.

At time t=t₃, the power supply to the 3/2-way valve PD2 is switched off so that it reaches position b (see FIG. 5A), and the connection between hydraulic line L4a (FIG. 4A) and the return stroke working chamber RH is disconnected, and the connection between the return stroke working chamber RH and the reservoir VB is established via the 3/2-way valve PD2, and the pressure in the return stroke working chamber RH P_{RH} drops to 0 bar at time t=t₃.

At time t=t₃, the 3/2-way valve PD1 is energized and switched to position a (see FIG. 5), thereby connecting the hydraulic line L4a (FIG. 4A) to the forward stroke working chamber VH, the pressure in the forward stroke working chamber VH P_{VH} and the pressure in the hydraulic line L4a (FIG. 4A), P_{L4a}, are thereby equalized to a value of Y bar between the pressure P_{VH}=0 bar in the pre-stroke working chamber VH and the pressure P(_{L4a})=Xbar in the hydraulic line L4a (FIG. 4A), P_{VH}=P_{L4a}=Y bar. Due to the slight forward stroke of the double-stroke piston DHK that now follows, the pressure supply DV delivers brake fluid from the forward stroke working chamber VH via the 3/2-way valve PD1 and via the 3/2-way valve US to the reservoir VB, and the pressure P_{L4a} in the hydraulic line L4a (FIG. 4A) increases due to the dynamic pressure via the second hydraulic connection HV2 of the 3/2-way valve US. This increase in pressure P_{L4a} is very rapid due to the high rigidity of the hydraulic system mentioned above. Due to the slight forward stroke of the double-acting piston h_{K}, the pressure in the return stroke working chamber RH P_{RH} reaches the suction pressure level when suctioning from the reservoir VB.

After the pressure in the hydraulic line L4a (FIG. 4A), P_{L4a}, has reached the pressure P_{RZ1-RZ4} in the wheel cylinders at time t=t₄, P_{L4a}=P_{RZ1-RZ4} the current of the 3/2-way valve US is switched off and the force of the spring VF of the 3/2-way valve US is sufficient to switch the valve to the de-energized state at a pressure difference P_{L4a}-P_{RZ1-RZ4}=0 bar. The connection between the hydraulic line L4a and the reservoir VB via the 3/2-way valve US is thus interrupted. The connection between the hydraulic lines L4a and L4 is thus reestablished via the 3/2-way valve US. The return stroke of the double-acting piston DHK h_{K} is initiated at time t=t₄ in accordance with the pressure reduction specification, which is specified, for example, by the driver and measured by the pedal travel sensor Sp or derived from the measurement, whereby the pressures in the wheel brake cylinders P_{RZ1-RZ4} in the brake circuit BK P_{BK} and in the return stroke working chamber RH P_{RH} follow the driver's pressure reduction request. The pressure in the return stroke working chamber RH P_{RH} remains at the dynamic pressure level when transferring from the return stroke working chamber RH via the 3/2-way valve PD2 to the reservoir VB.

This achieves an important function, namely to implement a 3/2-way valve in PD1 and PD2 as well as in the 3/2-way valve US without additional effort, with a large cross-section and low pressure losses.

Example embodiments of the present invention may include any of the following items.
[Item 1] Braking system with at least two hydraulic wheel brakes (RZ₁₋₄) each of which is assigned switching valves (SV₁₋₄), an electromotor-driven pressure supply device (DV) which has a piston-cylinder system whose piston (DHK) delimits two working chambers (VH, RH), wherein the first working chamber (VH) is connected to a brake circuit (BK1, BK) via a hydraulic connection (HL2) to a brake circuit (BK2, BK), and the second working chamber (RH) is connected via a further hydraulic connection (HL1) to a brake circuit (BK1, BK), wherein a 3/2-way valve (PD1, PD2) is arranged in at least one of the two hydraulic connections (HL1, HL2), which serves to selectively establish a hydraulic connection between the working chamber (VH, RH) and a hydraulic connection (R) leading to a reservoir (VB) or to a brake circuit (BK1, BK2, BK), characterized in that either in the hydraulic connection (L4) connecting the switching valves (SV₁₋₄) with the 3/2-way valve (PD1, PD2) is arranged a valve (US, MVₜ) with which the hydraulic connection between the switching valves (SV₁₋₄) and the at least one 3/2-way valve (PD1, PD2) can be interrupted, and/or the switching valves (SV₁₋₄) do not have integrated or parallel-connected check valves.
[Item 2] Braking system according to Item 1, characterized in that the valve is either a 2/2-way shut-off valve (MVₜ) or a 3/2-way valve (US), wherein the 3/2-way valve (US) can be selectively connected to the pressure supply (DV) with brake circuit (BK) or to the reservoir (VB).
[Item 3] Braking system according to Item 1 or 2, characterized in that a switching valve (SiV_{VH}, SiV_{RH}, SiV) and/or a suction valve (SaV1, SaV2) is provided for selectively shutting off and opening a hydraulic line (R) which connects at least one working chamber (VH, RH) of the pressure supply device (DV) to the reservoir (VB).
[Item 4] Braking system according to Item 3, characterized in that the suction valve (SaV1, SaV2) is arranged in series with the switching valve (SiV_{VH}, SiV_{RH}, SiV) arranged in the hydraulic line (R) for selective shutting off and opening.
[Item 5] Braking system according to one of the preceding Items, characterized in that the brake system has a master brake cylinder (HZ, THZ, SHZ) which can be controlled or actuated via a brake pedal (1) and at least one working chamber (R1) of which can be connected either to a road simulator (WS) or to a brake circuit (BK, BK1, BK2) by means of a 3/2-way valve (TV).
[Item 6] Brake system according to one of the preceding Items, characterized in that the 3/2-way valve (PD1, PD2) is in a first switching position (Pos b) when it hydraulically connects the respective working chamber (VH, RH) to the reservoir (VB), and in that the 3/2-way valve (PD1, PD2) is in a second switching position (Pos a) when it hydraulically connects the respective working chamber (VH, RH) to the brake circuit (BK1, BK2, BK) or hydraulic line (L4, L4a), wherein, in particular, the first switching position (Pos b) is the position in which the valve is in the de-energized state.
[Item 7] Braking system according to one of the preceding Items, characterized in that, by means of a drive (M), the double-stroke piston (DHK) of the piston-cylinder system of the pressure supply device (DV) is movable or adjustable in a forward stroke direction in which the volume of the first working chamber (VH) is reduced and in a return stroke direction in which the volume of the other second working chamber (RH) is reduced.
[Item 8] Braking system according to one of the preceding Items, characterized in that the 3/2-way valve (PD1) is arranged in a hydraulic connection (HL2), with which the respective working chamber (VH) can be selectively connected to the brake circuit (BK2, BK) or hydraulic line L4a or L4 or the reservoir (VB), and that either a 2/2-way valve for selectively opening and closing the hydraulic connection (HL1) or also a 3/2-way valve (PD2) is arranged in the other hydraulic connection (HL1), with which the respective working chamber (RH) can be selectively connected to the brake circuit (BK1, BK) or hydraulic line (L4a, L4) or the reservoir (VB).
[Item 9] Braking system according to one of the preceding Items, characterized in that the switching valves (SV₁₋₄) are modified standard inlet valves of an ABS system which do not have a check valve or are replaced by standard inlet valves (EV₁₋₄) of an ABS system.
[Item 10] Brake system according to one of the preceding Items, characterized in that the 3/2-way valve (US) has two valve actuators (VSK1, VSK2) and two cooperating valve seats (VS1, VS2), the first valve actuator (VSK1) being mounted in a first valve chamber (K1) and the second valve actuator (VSK2) being mounted in a second valve chamber (K2) so as to be displaceable, and in that a third valve chamber (K3) is located between the first and second valve chambers (K1, K2), and that a hydraulic connection to the brake circuit (BK, BK1, BK2) leads into the first valve chamber (K1), and that the second chamber (K2) is hydraulically connected to the reservoir (VB) and the third valve chamber (K3) is hydraulically connected to the pressure supply device (DV) by a hydraulic connecting line (L4a).
[Item 11] Method for operating a brake system, in particular according to the generic term of Item 1 or in particular according to one of Items 1 to 10, wherein the brake system has at least two hydraulic wheel brakes (RZ₁₋₄), each of which is assigned a switching valve (SV₁₋₄) and an electrically motor-driven pressure supply device (DV) which has a piston-cylinder system whose double-stroke piston (DHK) delimits and separates two working chambers (VH, RH) from each other, wherein the first working chamber (VH) is connected to the brake circuit (BK2, BK) via a hydraulic connection (HL2) and the second working chamber (RH) is connected to the brake circuit (BK1, BK) via a hydraulic connection (HL1), wherein at least one 3/2-way valve (PD1, PD2) is arranged in one hydraulic connection (HL1, HL2) is arranged a 3/2-way valve (PD1, PD2) with which the respective working chamber (VH, RH) can be selectively connected in a first switching position (Pos b) to the reservoir (VB) and in a second switching position (Pos a) to a brake circuit (BK1, BK2, BK), characterized in that, before the 3/2-way valve (PD1, PD2) is switched to its second switching position (Pos a), in which a hydraulic connection is then established between the one working chamber (VH, RH) of the pressure supply device (DV) and the hydraulic connection (L4a) leading to the switching valves (SVᵢ₌₁₋₄), the hydraulic pressure acting at least on the valve (PD1, PD2) to be switched is reduced or lowered.
[Item 12] Method according to Item 11, characterized in that the pressure reduction is effected by adjusting the piston (DKV) of the pressure supply device (DV) and/or by establishing a connection to a reservoir (VB) or a pressure relief device.
[Item 13] Method according to Item 11 or 12, characterized in that the pressure is reduced (t₂ to t₃), in particular below a predetermined threshold value (P_{threshold}), and that only thereafter (t₃) the 3/2-way valve (PD1, PD2) is switched to its second switching position (pos a) by means of its drive (4, 5, 6).
[Item 14] Method according to one of Items 11 to 13, characterized in that either
   both switching valves (PD1, PD2) are 3/2-way valves which are suitable for connecting the respective working chamber (VH, RH) either to the brake circuit (BK1, BK2, BK) or with the reservoir (VB) or
   only one of the two switching valves is a 3/2-way valve (PD1) and the other is a 2/2-way valve (PD2), whereby the 3/2-way valve (PD1) is suitable for hydraulically connecting the working chamber (VH) either to the brake circuit (BK2, BK) or with the reservoir (VB), and the 2/2-way valve (PD2) is only suitable for selectively shutting off or opening the hydraulic connection (HL1) between the working chamber (RH) and the brake circuit (BK1, BK).
[Item 15] Method according to one of Items 11 to 14, characterized in that, before the pressure is lowered, the brake circuit (BK) and/or the wheel brake cylinders (RZ₁₋₄) are hydraulically decoupled from at least one to be switched valve (PD1, PD2) by closing at least one valve (MVt, US, SV₁₋₄, EV₁₋₄), such that the pressure (P_{RZ1}-P_{RZ4}) enclosed in the wheel brake cylinders (RZ₁₋₄) or the pressure (P_{BK}) enclosed in the brake circuit (BK) does not change during and as a result of the pressure reduction.
[Item 16] Method according to one of Items 11 to 15, characterized in that, before switching between the forward stroke and return stroke of the piston (DHK) of the pressure supply device (DV), the valves (PD1, PD2) initially remain in their switching positions (Pos a, Pos b), and in a first method step (t₁ to t₂)
   a) either all switching valves (SVᵢ₌₁₋₄) which are not yet closed are closed so that the wheel-brake cylinders (RZ1-4) are disconnected from the pressure supply device (DV) and the valves (PD1, PD2), or
   b) a switching valve (MVₜ, US) arranged in the hydraulic connection (L4, L4a) is switched in such a way that the brake circuit (BK) or the wheel brake cylinders (RZ1-4) are disconnected from the pressure supply device (DV) and the valves (PD1, PD2), and that in a subsequent process step, which may also overlap slightly in time with the previous process step, a pressure reduction is effected in the part (L4a) of the hydraulic connection (L4) which is still hydraulically connected to the valves (PD1, PD2), in particular to a predetermined threshold value (P_{threshold}), whereby this is done either by adjusting the double-acting piston (DHK) (t₂ to t₃) or by establishing a short-term (t₂ to t₃) hydraulic connection between the reservoir (VB) and the hydraulic connection (L4a), in particular via the valve (US) or via the master brake cylinder (HZ, THZ, SHZ) and the shut-off valve (TV), and that after the required pressure reduction has been achieved, the switch positions (Pos a, Pos b) of both valves (PD1, PD2) are changed, in particular simultaneously, via corresponding control at (t₃) , and that afterwards, or with a slight time overlap (t₄), the valves (US, MVₜ, SVᵢ₌₁₋₄) closed in the first step of the process are reopened, after which the pressure change continues via the valve (PD1, PD2) now in the second switching position (Pos a).
[Item 17] Method according to Item 16, characterized in that the valve (US) is a 3/2-way valve which, in its first switching position, connects the pressure supply device (DV) to the brake circuit (BK) and, in its second switching position, connects the pressure supply (DV) to the reservoir (VB).
[Item 18] Method according to one of Items 11 to 17, characterized in that a switching valve (SV₁₋₄) has no parallel-connected check valve or is an ABS standard inlet valve (EV₁₋₄) with a check valve.
[Item 19] Method according to one of Items 11 to 18, characterized in that the control and regulation unit (ECU) monitors the position of the piston (DHK) of the pressure supply device (DV), and in that the ECU calculates whether the piston travel or stroke (h_{K}) in the current direction of movement of the piston is sufficient to achieve the pressure to be set in the wheel brake cylinders, and that when a necessary reversal of direction and the associated switchover from one valve (PD1, PD2) to the other is detected, the switchover process is initiated.
[Item 20] Method according to one of Items 11 to 19, characterized in that the 3/2-way valve (PD1, PD2) has two valve actuators (VSK1, VSK2) and two cooperating valve seats (VS1, VS2), wherein the first valve actuator (VSK1) is mounted in a first valve chamber (K1) and the second valve actuator (VSK2) is mounted in a second valve chamber (K2) in a displaceable manner, and that a third valve chamber (K3) is located between the first and second valve chambers (K1, K2), and that a hydraulic connection to the reservoir (VB) opens into the first valve chamber (K1), and that the second chamber (K2) is hydraulically connected to a brake circuit (BK1, BK2, BK) and the third valve chamber (K3) is hydraulically connected to a working chamber (VH, RH) of the pressure supply device (DV).
[Item 21] Method according to Item 19, characterized in that a valve spring (VF) located in the second valve chamber (K2) applies force to the second valve actuator against the second valve seat (VS2), and that by means of an electric and/or electromagnetic drive (4, 5, 6), the first valve actuator (VSK1) can be pressed against the first valve seat (VS1) or moved away from it, wherein a spacer element (ST) arranged, fixed or molded in particular on the first valve actuator (VSK1), keeps the two valve actuators at a minimum distance such that when the first valve actuator (VSK1) rests against the first valve seat (VS1), the second valve actuator (VSK2) is kept at a distance from the second valve seat (VS2).
[Item 22] Method according to Item 20 or 21, characterized in that the opening cross-sectional area (A1) between the first valve seat (VS1) and the first valve actuator (VSK1) spaced apart from it is smaller than the opening cross-sectional area (A2) between the second valve seat (VS2) and the second valve actuator (VSK2) spaced apart from it, wherein the ratio of areas A2/A1 is at least 1.5 to 2.
[Item 23] Method according to Items 20, 21, or 22, characterized in that, in order to reduce the required motor torque of the pressure supply device (DV), both 3/2-way valves (PD1, PD2) are open, while the double-stroke piston (DHK) of the pressure supply device (DV) is in the forward stroke movement, such that part of the hydraulic medium conveyed out of the forward stroke working chamber (VH) enters the return stroke working chamber (RH) via the one valve (PD2), thus enabling a higher pressure to be achieved in the brake circuit with lower motor torque.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A braking system comprising:
at least two hydraulic wheel brakes;
switching valves provided for the at least two hydraulic wheel brakes; and
an electromotor-driven pressure supply device including a piston-cylinder system including a piston that delimits a first working chamber and a second working chamber; wherein
the first working chamber is connected to a first brake circuit via a first hydraulic connection to a second brake circuit, and the second working chamber is connected via a second hydraulic connection to the first brake circuit;
at least one 3/2-way valve is provided in at least one of the first and second hydraulic connections to selectively establish a hydraulic connection between the first or second working chamber and a third hydraulic connection leading to a reservoir or to the first or second brake circuit;
in a fourth hydraulic connection connecting the switching valves with the at least one 3/2-way valve, an additional valve is provided to interrupt the fourth hydraulic connection between the switching valves and the at least one 3/2-way valve; and/or.

2. The braking system according to claim 1, wherein
the additional valve is either a 2/2-way shut-off valve or a 3/2-way valve; and
the at least one 3/2-way valve is selectively connectable to the electromotor-driven pressure supply device with the first or second brake circuit or to the reservoir.

3. The braking system according to claim 1, wherein a switching valve and/or a suction valve is provided to selectively shut off and open the third hydraulic connection which connects at least one of the first or second working chamber of the pressure supply device to the reservoir.

4. The braking system according to claim 1, wherein the at least one 3/2-way valve is in a first switching position when the at least one 3/2-way valve hydraulically connects the respective first or second working chamber to the reservoir, and
the at least one 3/2-way valve is in a second switching position when the at least one 3/2-way valve hydraulically connects the respective first or second working chamber to the first or second brake circuit or the fourth hydraulic connection; and
the first switching position is a position in which the at least one 3/2-way valve is in a de-energized state.

5. The braking system according to claim 1, further comprising a drive to move or adjust a double-stroke piston of the piston-cylinder system of the pressure supply device in a forward stroke direction in which a volume of the first working chamber is reduced and in a return stroke direction in which a volume of the second working chamber is reduced.

6. The braking system according to claim 1, wherein
the at least one 3/2-way valve is provided in the first hydraulic connection with which the respective first working chamber is selectively connectable to the first or second brake circuit or the fourth hydraulic connection or the reservoir; and
either a 2/2-way valve to selectively open and close the second hydraulic connection or a 3/2-way valve is provided in the second hydraulic connection, with which the respective second working chamber can be selectively connected to the first or second brake circuit or the fourth hydraulic connection or the reservoir.

7. A method for operating a braking system including at least two hydraulic wheel brakes each provided with a switching valve,
and an electrically motor-driven pressure supply device including a piston-cylinder system including a piston that defines a first working chamber and a second working chamber,
the first working chamber being connected to a first brake circuit via a first hydraulic connection to a second brake circuit, and the second working chamber being connected via a second hydraulic connection to the first brake circuit, at least one 3/2-way valve being provided in at least one of the first and second hydraulic connections and selectively connected in a first a first switching position to a reservoir and in a second switching position to the first or second brake circuit, the method comprising:
before the at least one 3/2-way valve is switched to the second switching position in which a third hydraulic connection is established between the first or second working chamber of the pressure supply device and a fourth hydraulic connection leading to the switching valves, reducing a hydraulic pressure acting at least on the at least one 3/2-way valve to be switched.

8. The method according to claim 7, wherein the reducing the hydraulic pressure includes adjusting the piston of the pressure supply device and/or establishing a connection to the reservoir or a pressure relief device.

9. The method according to claim 7, wherein the hydraulic pressure is reduced below a predetermined threshold value, and
thereafter the at least one 3/2-way valve is switched to the second switching position by a drive.

10. The method according to claim 7, wherein, before the hydraulic pressure is reduced, the first or second brake circuit and/or wheel brake cylinders are hydraulically decoupled from the at least one 3/2 valve to be switched by closing the additional valve such that a pressure in wheel brake cylinders or a pressure in the first or second brake circuit does not change during and as a result of the pressure being reduced.

11. The method according to claim 7, wherein, before switching between a forward stroke and a return stroke of the piston of the pressure supply device, the at least one 3/2 valve initially remains in the first or second switching position; and in one step:
a) all of the switching valves which are not yet closed are
b) the additional valve in the fourth hydraulic connection is switched in such a way that the first or second brake circuit or the wheel brake cylinders are disconnected from the pressure supply device and the at least one 3/2-way valve; and in a subsequent step:
reducing a pressure in a portion of the fourth hydraulic connection which is still hydraulically connected to the at least one 3/2 valve to a predetermined threshold value by adjusting the double-acting piston or by establishing a temporary hydraulic connection between the reservoir and the fourth hydraulic connection via the additional valve or via a master brake cylinder and a shut-off valve, and after a required pressure reduction has been achieved, the first and second switching positions of the at least one 3/2-way valve are changed simultaneously or substantially simultaneously, via corresponding control, and afterwards, the additional valve or the switching valves closed previously are reopened, after which the pressure change continues via the at least one 3/2-way valve in the second switching position.

12. The method according to claim 7, wherein a control and regulation unit monitors a position of the piston of the pressure supply device, and the control and regulation unit calculates whether a piston travel or stroke in a current direction of movement of the piston is sufficient to achieve a pressure to be set in the wheel brake cylinders, and when a necessary reversal of direction and an associated switchover from one of the at least one 3/2-way valve to another is detected, a switchover process is initiated.

13. The method according to claim 7, wherein
the at least one 3/2-way valve includes two valve actuators and two cooperating valve seats; and
the first valve actuator is mounted in a first valve chamber and the second valve actuator is mounted in a second valve chamber in a displaceable manner, and a third valve chamber is located between the first and second valve chambers,
and a hydraulic connection to the reservoir opens into the first valve chamber, and the second chamber is hydraulically connected to the first or second brake circuit and the third valve chamber is hydraulically connected to the first or second working chamber of the pressure supply device.

14. The method according to claim 13, wherein a valve spring located in the second valve chamber applies a force to the second valve actuator against the second valve seat, and an electric and/or electromagnetic drive moves the first valve actuator toward or away from the first valve seat;
a spacer element on the first valve actuator keeps the first and second valve actuators at a minimum distance such that when the first valve actuator rests against the first valve seat, and the second valve actuator is kept at a distance from the second valve seat.

15. The method according to claim 14, wherein an opening cross-sectional area A1 between the first valve seat and the first valve actuator spaced therefrom is smaller than an opening cross-sectional area A2 between the second valve seat and the second valve actuator spaced therefrom; and
a ratio of areas A2/A1 is at least 1.5 to 2.

16. The method according to claim 14, wherein, in order to reduce a required motor torque of the pressure supply device, both of the at least one 3/2-way valves are open, while the double-stroke piston of the pressure supply device is in a forward stroke movement, such that a portion of a hydraulic fluid conveyed out of a forward stroke working chamber enters a return stroke working chamber via one of the at least one 3/2-way valve, thus enabling a higher pressure to be achieved in the brake circuit with lower motor torque.

17. A method for operating the braking system according to claim 1, the method comprising:
before the at least one 3/2-way valve is switched to the second switching position in which the third hydraulic connection is established between the first or second working chamber of the pressure supply device and the fourth hydraulic connection leading to the switching valves, reducing a hydraulic pressure acting at least on the at least one 3/2-way valve to be switched.

18. The method according to claim 17, wherein the reducing the hydraulic pressure includes adjusting the piston of the pressure supply device and/or establishing a connection to the reservoir or a pressure relief device.
